(19) United States
(12) Patent Application Publication
(10) Pub. No.: US 2007/0243455 A1
(43) Pub. Date: Oct. 18, 2007

(54) Machinable and hand-mouldable compound

(76) Inventor: Carson J. Manning, Scarborough (CA)

Correspondence Address: D.W. EGGINS, 18 DOWNSVIEW DRIVE, BARRIE, ON, L4M 4P8, CA

(21) Appl. No.: 11/403,946

(22) Filed: Apr. 14, 2006

(51) Int. Cl. H01M 2/00

(52) U.S. Cl. 429/63

(57) ABSTRACT

A compound, Phyxall (T.M.), is available on the Internet as a multi-purpose filler. It contains glass microbeads and solidifies rapidly by the addition of a liquid glue component. Previously used to mend vinyl pool liners, the compound has unexpectedly been found to have unusual adherent and sealing qualities for bridging voids, such as repairing lines that carry water and aromatic compounds, such as brake, hydraulic, transmission and air conditioning fluids. The compound elements may be used directly to patch the void, being applied as progressive bridging layers for a sealing patch over the void. The applied compound resists extremes of temperature and high loadings.

### CROSS-REFERENCE TO RELATED APPLICATIONS

Not Applicable (N/A)

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING

N/A

### COMPACT DISC APPENDIX

N/A

### BACKGROUND OF THE INVENTION

1. This invention is directed to a new set of uses for an existing compound.

The compound, Phyxall(T.M.), is sold by me on the Internet, as two industrial adhesives, comprising a powdered filling material; in combination with a liquid glue component for a wide range of applications. Originally intended as a patching material for vinyl pool liners, I have recently found that my Fill/Fix material has quite unexpected properties that include enabling its use for: repairing damaged and fractured items, wherein significant sized fissures can be bridged, using the two fluid elements of the material, in the form of a liquid and a fine powder, to build across extensive fissures, and enabling the repairing of ruptured water and fuel lines, gas, brake and air conditioning lines, and the cold bonding of metal to metal.

2. There has been a long-felt need for materials that can be used for immediately and effectively repairing damaged objects. A particularly challenging requirement has been the repair of ruptured lines, including water and fuel lines. However, up to the present, this need has not apparently been met.

### BRIEF SUMMARY OF THE INVENTION

The present invention provides a material and method of its use, for carrying out effective, rapid bridging repair of damaged articles, including such as ruptured water and fuel lines in an effective and economical fashion.

A compound, Phyxall, sold by me on the Internet as an all-purpose filler contains glass microbeads and is used in combination with a binder glue. The fluent, talcum-like filler is solidified by the addition of the glue, which appears to serve also as a form of catalyst, the two materials, when combined having an extremely rapid cure time, allied with high adherence.

The original use for the compound elements was to mend tears in vinyl pool liners. The product is readily available to the public, in accordance with the foregoing information.

After considerable utilization, in its advertised environment, it was found that the compound had some highly unusual properties which enabled its use in unexpected fashions, and with unusual adherent and sealing qualities, including adhering to a range of types of materials: fiberglass, plastics, wood, stone, glass, rubber and metals.

In the following disclosure the two component parts of the Phyxall repair and structural compound will be referred to as “filler component” and “glue component” respectively.

The filler component contains glass microbeads and is totally fluent, and may be applied from a tube dispenser as a fine powder; the glue component being a low viscosity liquid which is also dispensed from a tube and diffuses extremely rapidly into the filler component. In restoring or repairing items wherein a significant gap or void has to be bridged, it has been found that, with the affected surfaces cleaned and debrided of loose material and any present dirt or oxides, the liquid glue component could be applied to local areas adjacent the void, to form wetted areas, and the filler component lightly ‘puffed’ from its dispensing tube onto the wetted areas, where it immediately solidified into a hard, tightly adherent layer. Succeeding applications of glue and filler can then be rapidly built up to bridge the void, and a covering ‘patch’ thus built up in sealing relation with the void.

This patch has been found to be very strong, and to be impervious to water and more volatile fluids, and to be substantially temperature insensitive.

For instance, it was found that the compound could be successfully used in locations where it came in contact, after installation, with water, and more significantly, with aromatic compounds, such as brake, hydraulic, transmission and air conditioning fluids

In the case of a leaking water, fuel, brake, hydraulic or air conditioning line, the line is depressurized and the outer surface is cleaned and dried. The liquid component of the Phyxall product may then be applied to the affected surface, and the fluent solid component added. This results in a rapid, leakproof and stress-resistant repair.

The compound possesses integrity over a wide range of temperatures, such that it can be used in a wide range of temperatures.

Owing to the extremely rapid setting-up rate of the compound, the affected apparatus is usually returned to service with minimal delay.

In the case of metal plates, the compound adhesive may be used as a bonding agent in somewhat the same fashion as a weldment, including machinability after bonding attachment, and build-up with the filler component.

Where the surfaces to be joined are in substantially flush-fitting relation, the liquid ‘glue’ may be used on its own, without the inclusion of the solid component.

It has also been found that the Phyxall compound, referred to hereinafter as “the compound”, has high adherent strength to a wide range group of differing materials, which enables strong adhesion of one such material to another material of the group, using the compound as the bonding agent.

The fluent, microbead-containing solid component of the compound is referred to as the ‘solid component’, and the glue component is referred to as the ‘liquid component’.

The group of compound-compatible materials which achieve high adherence includes most metals, fiberglass, many plastics, wood, stone, glass and rubber, but excludes: cloth, paper, Teflon (T.M.), and polyethylene and polypropylene.

The present invention thus provides a joint bonding system having a bonding compound with a filler component that includes microbeads and a glue component, referred to as the liquid component, the bonding compound being used in the form of a built-up, high strength coherent patch adhered in leakproofing relation with lines conducting liquids selected from the group consisting of water and aromatic fluids, including hydraulic, brake, transmission and air conditioning fluids.

The subject joint bonding compound may be used in intimate bonded relation with objects comprising materials selected from the group consisting of metals, fiberglass, plastics, wood, stone, glass, rubber and ceramics.

The method of patching by means of the subject two-component compound, and sealing a void-impaired liquid-carrying line used in transferring a liquid selected from the group consisting of water, brake, transmission and air conditioning fluids, comprises the steps of: drying contact wall areas of that void; ensuring an access path for penetration of the compound to the contact wall areas, which may include having to widen narrow voids such as cracks; debriding and cleaning the void wall and adjacent wall areas of the line; applying a first component of the compound in intimate contact with the contact wall areas of the void and the adjacent outer wall areas of the line; applying the second component of the compound to the first component to initiate bonding of the compound to the void wall in sealing relation therewith, and permitting the compound to cure, in a dry and unpressurized condition. Applications of the two components may be repeated where necessary to effect bridging across a fissure.

The aforesaid method may require the step of immobilizing portions of the body adjacent the void against relative movement during the application and curing of the compound.

### BRIEF DESCRIPTION OF THE SEVERAL VIEWS OF THE DRAWING

Certain embodiments of the present invention are described by way of example, without limitation thereto, other than as set forth in the accompanying claims; it being understood that persons skilled in the art may make other uses, within the ambit of the claims, reference being had to the accompanying drawings, wherein:

FIGS. 1A and 1B are end sections showing bonded metal plates joined by the compound of the present invention;

FIG. 1C is an end view showing a portion of a repaired footing, using the compound in accordance with the present invention; and FIG. 1D is an end view of a cracked metal plate, as repaired in accordance with the present invention;

FIG. 2 is a perspective view of a portion of a fractured pipe line;

FIG. 3 is a view similar to FIG. 2, of the line repaired with the compound;

FIG. 4 is a block diagram detailing the steps of the process associated with FIG. 3;

FIG. 5 is a sketch based upon photographic record showing a side view of failed water supply fittings;

FIG. 6 is an end view sketch of a component portion of FIG. 5, after repair in accordance with the present invention;

FIG. 7 is a perspective view of a damaged elbow of an electrical conduit; and,

FIG. 8 is a perspective view of the repaired elbow, and the bottles, of liquid and powder of the subject compound, used in effecting the repair.

### DETAILED DESCRIPTION OF THE INVENTION

Referring to FIGS. 1A and 1B there are shown joints 10 and 12, respectively having a moderately thick plate 14, 14 with a thick section plate 16, 16 bonded thereto.

In FIG. 1A the joint 10 is a T-section, having bonding beads 18 on each side of the joint, in the fashion of fillet welds; and in FIG. 1B, the joint 12 is an L-section, having a bonding bead 20 in the angle between the plates 14 and 16, in the fashion of a fillet weld. In the case of the L-joint of FIG. 1B, the external ‘root’ where the plates 14 and 16 meet to form a flush surface, one or both of the plates 14,16 have the corner edge beveled so as to form a groove within which an exterior bonding bead 20 is located.

Referring to FIG. 1C, a column 24 with foot fillets 26, 27 is illustrated wherein the formerly broken fillet 27 has been restored by use of the subject compound.

Turning to FIG. 1D, a member 30 has a penetrating local crater or imperfection 31 that has been filled at 32 with the compound. In accordance with the use and aesthetics of the member 30, when the compound fill 32 has fully cured (over a matter of a few minutes), the excess surface material of fill 32 may be machined off or otherwise refinished.

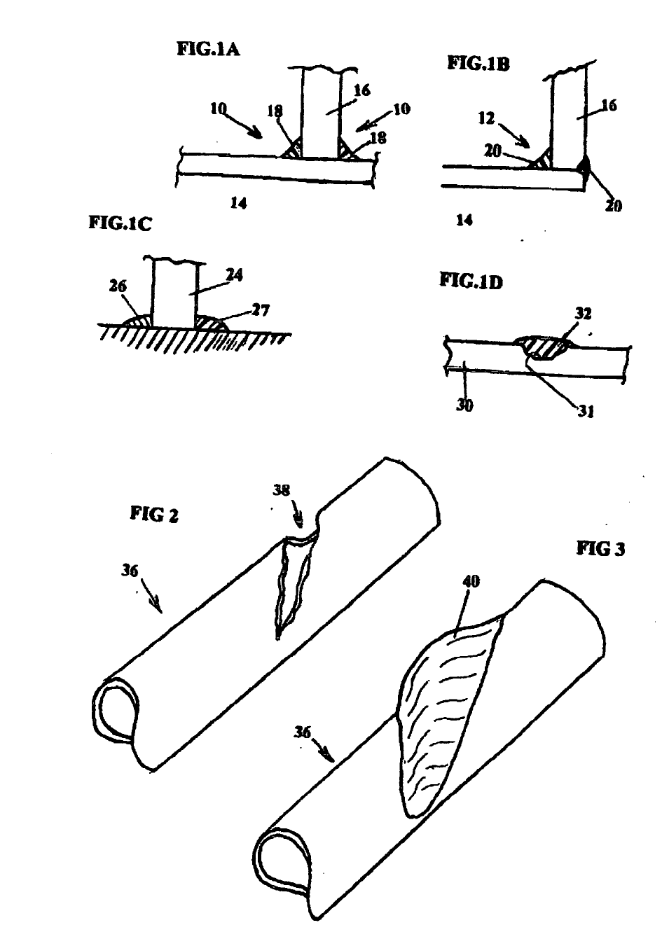

Turning to FIG. 2, a portion 36 of a pipe is shown, having a penetrating fracture 38 extending through its wall.

In FIG. 3 the pipe portion 36 is shown having a patch 40 of the subject compound built up in bridging, sealing relation, as detailed below. In such an instance the patch 40 is usually left in its piecemeal moulded form, to better facilitate subsequent monitoring of system integrity when scanning for leaks.

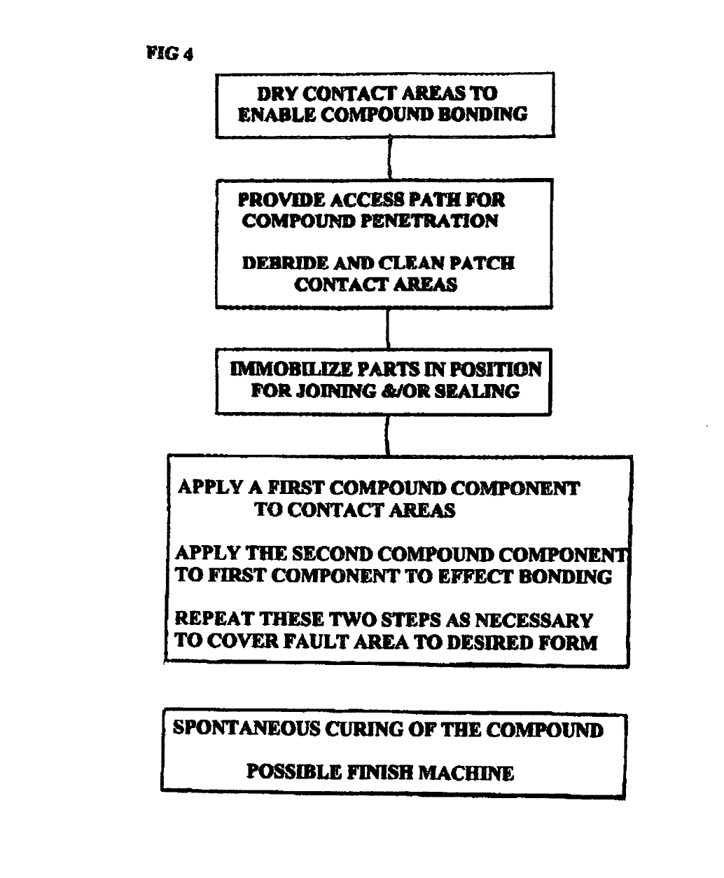

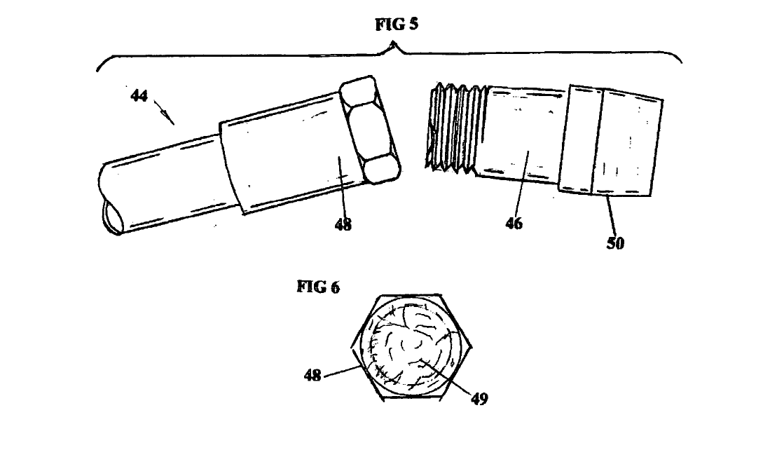

Turning to FIG. 4, the process steps normally followed in applying the compound, as in the foregoing examples, may include some or all of the following steps.

For leaking pipes such as water, fuel lines, brake lines, etc, the damaged line is first depressurized, and the fluid level within the pipe is lowered below the leakage state, such that the fracture can be dried and decontaminated.

The area to which the compound is to be applied is first debrided, to remove any loose or unwanted material. This includes in some instances, such as a pipe with a hairline crack, the opening up of the crack to permit at least partial penetration of the compound into the fracture. The debrided surfaces are then cleaned using an acetone-based cleaning agent, to ensure the total removal of all grease.

The parts to be joined or sealed are then immobilized in their desired final spatial relationship. The solid component of the compound is then applied in the desired areas, and the liquid component is then added, to bond and initiate cure of the joint.

In instances where the fissure is wide, such as in a ruptured fuel or hydraulic line, so that undesired filling of the hollow line may occur, the following procedure has been used successfully:

an external area of line bounding the fissure is cleaned, as detailed above, and the area is wetted with the liquid ‘glue’. The filler powder is then squirted onto the wetted area, and bonds immediately to the outer surface of the line, while also encroaching on the fissure. The wetting and powdering steps are then repeated, each time further encroaching across the fissure, until the fissure is bridged. At this juncture, the powder may be applied first, to a desired thickness, and the liquid glue added, to set it up and bond it to the underlying strata, until a desired degree of build-up is achieved.

After a brief cure period, the accessible surfaces of the treated joint may be machined, where practical and desirable for functional or aesthetic purposes.

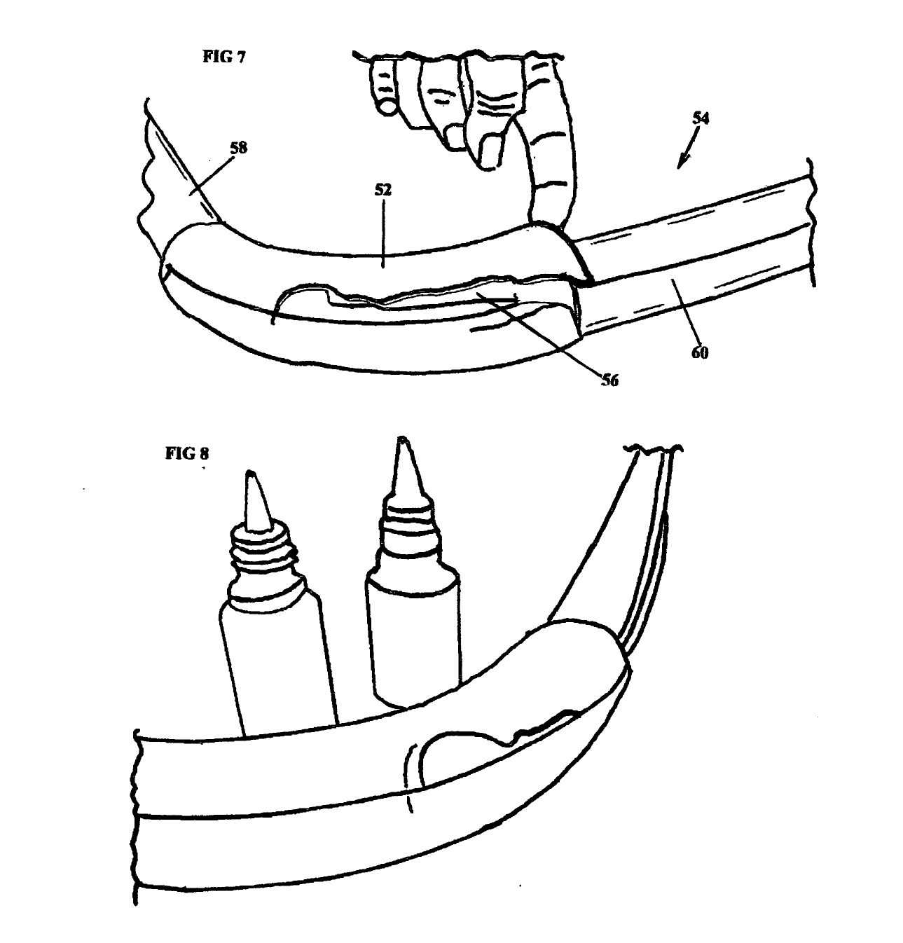

Turning to FIGS. 5 and 6, a water supply pipe 44 was originally capped off by way of a nipple 46 that was threaded into a bushing 48, the nipple 46 being sealed by a cap 50. Over the course of time the threads of the nipple 46 had corroded, as can be seen, such that a steady jet of water issued, when subject to water mains pressure (approx 80 psi).

As shown in FIG. 6, the open end of bushing 48 was progressively built up by sequential applications of filler material. The open, annular end surface of bushing 48 was first cleaned and degreased with an acetone-based cleaner, and a layer of glue liquid was applied over the cleaned annular end surface of bushing 48, and the powdered filler squirted onto the still-wet glue, where it immediately solidified and bonded to the bushing 48. This application process was repeated, each time progressing radially inwardly, until finally the end opening of bushing 48 was fully enclosed. Additional filler was added for strength reinforcement, and bonded into place by the addition of glue to form the closure 49.

Upon reassembly with the water system, and turning on of the main shut-off, full mains pressure (approx 80 p.s.i.) was applied to the now-sealed bushing 48, without trace of any leakage. The defective parts were ultimately replaced five months later. Meanwhile, the capped-off bushing 48 had shown no trace of failure or leakage.

Turning to FIGS. 7 and 8, the conduit elbow 52 of an electrical wiring system 54 had a severe crack 56, which could be readily deformed as shown, (the drawing being exerpted from an actual photograph}, which crack 56 totally negated the safety of the enclosed wiring system. It will be understood that in this circumstance system integrity would normally require replacement of the damaged elbow 52, which would involve disconnecting, removing, and subsequently reconnecting all of the contained conductors, with disassembly and reassembly of the related conduits 58, 60 with a replacement elbow.

In this instance, the crack 56 of broken elbow 52 was clamped shut, using a C-clamp, and the liquid glue applied to the resultant crack. Any small remaining fissures were filled by the application of filler powder, which bonded with the glue, to totally enclose the elbow 52, thereby restoring the integrity of the conduit system. This work was carried out with the conductors in place and undisturbed. The strength of the repaired elbow 52 appeared to exceed the original strength of an undamaged elbow, and no cracks or fissures could be detected.

1. A joint bonding system having a bonding compound with a powder filler component that includes microbeads, referred to as the powder component, and a liquid, glue component, referred to as the liquid component, said bonding compound being used in the form of an adherent patch applied in leakproofing relation with lines conducting liquids selected from the group consisting of water and aromatic fluids, including brake, transmission and air conditioning fluids.

2. The bonding system as set forth in claim 1, having said bonding compound in intimate bonded relation with objects comprising materials selected from the group consisting of metals, fiberglass, plastics, wood, stone, glass, rubber and ceramics.

3. The bonding system as set forth in claim 1, said adherent patch comprising a plurality of individual strata applied in cumulative bonding relation with underlying strata, extending in bridging relation over a void in the wall of said line.

4. The method of patching by means of a two-component compound, and sealing a void- impaired liquid-carrying line used in transferring a liquid selected from the group consisting of water, brake, hydraulic, transmission and air conditioning fluids, comprising the steps of: drying external, contact wall areas of said void; ensuring an access path for penetration of said compound to said contact wall areas; debriding and cleaning wall areas of said line surrounding said void; applying a first component of said compound in intimate contact with said surrounding wall areas; applying the second said component of said compound to said first component to initiate bonding of said compound to said surrounding wall area in sealing relation therewith, and permitting said compound to cure, in a dry and unpressurized condition.

5. The method as set forth in claim 4, including the step of immobilizing portions of said line adjacent said void against relative movement during the application and curing of said compound.

6. The method as set forth in claim 4, wherein said first applied component is a liquid glue.

7. The method as set forth in claim 4, wherein said first applied component is a powder containing microspheres.

8. The method as set forth in claim 6, including applying a plurality of layers of said compound in overlying, overlapping relation with an underlying layer, in cumulative bridging relation with said void.
